(19) United States
(12) Patent Application Publication
(10) Pub. No.: US 2005/0254526 A1
(43) Pub. Date: Nov. 17, 2005

(54) Parameter sets update in streaming applications

(75) Inventors: Ye-Kui Wang, Tampere (FI); Miska Hannuksela, Kangasala (FI); Emre Baris Aksu, Tampere (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/844,668

(22) Filed: May 12, 2004

(51) Int. Cl. H04L 1/00; H04L 12/26; H04J 1/16; H04J 3/14

(52) U.S. Cl. 370/503

(57) ABSTRACT

A system and method provide for updating a parameter set in streaming applications. The method includes receiving a first parameter set from a server device at a client device, receiving an updated parameter set having synchronization information at the client device, wherein the updated parameter set is sent from the server device using a Real Time Streaming Protocol (RTSP) method or Session Description Protocol, processing a bitstream received from the server device at the client device using the first parameter set, and processing the bitstream at the client device using the updated parameter set when the synchronization information indicates that the updated parameter set should be used. The synchronization information may include, but is not limited to, a real-time transport protocol timestamp, a normal play time timestamp, network abstraction layer unit time, and a decoding order number. The RTSP method may include, but is not limited to, a SET_PARAMETER method, a GET_PARAMETER method, a PAUSE method, a PLAY method, a OPTIONS method, a DESCRIBE method and a PING method.

### FIELD OF THE INVENTION

The present invention is related to multimedia data streaming. More particularly, the present invention relates to a system and a method for parameter set update in streaming applications.

### BACKGROUND OF THE INVENTION

Streaming refers to the ability of an application to play synchronized media streams like audio and video streams in a continuous way while those streams are being transmitted to a client over a data network. Applications, which can be built on top of streaming services, can be classified into on-demand and live information delivery applications. Examples of on-demand information delivery applications are music and news-on-demand applications. Live information delivery applications include the live delivery of radio and television programs. The 3^{rd} Generation Partnership Project (3GPP) Packet-switched Streaming Service (PSS) provides a framework for Internet Protocol (IP) based streaming applications over 3G networks. The 3GPP transparent end-to-end PSS specifications consists of six 3GPP Technical Specifications (TSs): 3GPP TS 22.233, 3GPP TS 26.233, 3GPP TS 26.234, 3GPP TS 26.235, 3GPP TS 26.244, 3GPP TS 26.245, and 3GPP TS 26.246. The TS 22.233 contains the service requirements for the PSS. The TS 26.233 provides an overview of the PSS. The TS 26.234 provides the details of protocol and codecs used by the PSS. The TS 26.235 provides the default codecs specification. The TS 26.244 defines the 3GPP file format used by the PSS and Multimedia Messaging Service (MMS) services. The TS 26.245 defines the timed text format used by the PSS. The TS 26.246 defines the 3GPP Synchronized Media Integration Language (SMIL) profile.

The Real Time Streaming Protocol (RTSP) is an application-level protocol for control over the delivery of data with real-time properties. The protocol is specified by the Internet Engineering Task Force (IETF) Request For Comment (RFC) 2326. RTSP provides an extensible framework to enable controlled, on-demand delivery of real-time data, such as audio and video data. Sources of data can include both live data feeds and stored clips (on-demand). The protocol is intended to control multiple data delivery sessions, to provide a means for choosing delivery channels such as User Datagram Protocol (UDP), multicast UDP, and Transmission Control Protocol (TCP), and to provide a means for choosing delivery mechanisms based upon the Real-Time Transport Protocol (RTP). While most real-time media will use RTP as a transport protocol, RTSP is not tied to RTP. In PSS, RTSP is used in the streaming of continuous media to provide session set-up and to control the individual media streams. RTSP is a text-based protocol. RTSP is intentionally similar in syntax and operation to the HyperText Transport Protocol (HTTP)/1.1 so that extension mechanisms to HTTP can in most cases also be added to RTSP.

An RTSP session typically consists of a client setting up a transport mechanism for the continuous media stream (SETUP) and then starting the stream with PLAY or RECORD. The stream may be paused temporarily using the PAUSE method. RTSP controls the stream, that may be sent via a separate protocol, independent of the control channel. For example, RTSP control may occur on a TCP connection while the data flows via UDP. This is known as use of an out-of-band transmission. Thus, data delivery to the client continues even if no RTSP requests are received by the media server. Also, during its lifetime, a single media stream may be controlled by RTSP requests issued sequentially on different TCP connections. Therefore, the server needs to maintain “session state” to be able to correlate RTSP requests with a stream.

RTP enables the controlled delivery of real-time data, such as audio, video, or simulation data. Sources of the data can include both live and on-demand content. RTP provides end-to-end network transport functions for applications transmitting real-time data over multicast or unicast network services. RTP supports content identification, sequence numbering, timing reconstruction, and delivery monitoring to the real-time applications. RTSP is designed to work with established protocols, such as RTP and HyperText Transfer Protocol (HTTP).

RTSP requires a presentation description. The Session Description Protocol (SDP), specified by IETF RFC 2327, is used as the format of the presentation description for both PSS clients and servers. PSS servers provide and clients interpret the SDP syntax according to the SDP specification and appendix C of the RTSP specification. The SDP specification requires that certain fields always be included in an SDP file while other fields may be defined and included if required for use relative to the specific stream or streams.

Live streaming includes a live source and one or more streaming servers that deliver the live stream to several downstream clients. Live streaming can also happen directly from a broadcaster as in the case of multicast or broadcast. To provide live streaming, the SDP file describing the live session is published by the streaming server typically using one of the following mechanisms: manually transferring the SDP file using the File Transfer Protocol (FTP) from the live source host to the streaming server host, using a webserver, or using email, etc. The live session can be accessed from the streaming server using the transferred SDP file.

Video coding standards include International Telecommunications Union-Telecommunications (ITU-T) H.261, International Organization for Standardization/International Electrotechnical Commission (ISO/IEC) Moving Picture Experts Group (MPEG)-1 Visual, ITU-T H.262 or ISO/IEC MPEG-2 Visual, ITU-T H.263, ISO/IEC MPEG-4 Visual and ITU-T H.264 or ISO/IEC MPEG-4 Advanced Video Coding (AVC). H.264/AVC has been developed by a Joint Video Team (JVT) of both ITU-T and ISO/IEC.

Conventional video coding standards (standards other than H.264/AVC) have specified a structure for an elementary bitstream, i.e., a self-contained bitstream that decoders can parse. The bitstream consists of several layers, typically including several of the following: a sequence layer, a group of pictures (GOP) layer, a picture layer, a slice layer, a macroblock layer, and a block layer. The bitstream for each layer typically consists of a header and associated data.

The syntax for H.264/AVC consists of Network Abstraction Layer (NAL) Units (NALUs). NALUs are classified into Video Coding Layer (VCL) and non-VCL NALUs. The VCL NALUs contain the data that represents the values of the samples in the video pictures. The non-VCL NALUs contain any associated additional information such as parameter sets and supplemental enhancement information. A stream of NALUs does not form an elementary bitstream because there are no start codes in NALUs. Instead, NALUs are framed with start codes according to Annex B of the H.264/AVC specification to form an elementary bitstream. H.264/AVC contains headers at the slice layer and below, but it does not include picture, GOP, or sequence headers. Instead, the concept of a parameter set was introduced to replace these headers.

A parameter set generally contains information that is expected to change infrequently. The parameter set provides the decoding of a large number of VCL NALUs. There are two types of parameter sets:
1) Sequence Parameter Sets (SPSs) that apply to a series of consecutively coded video pictures called a coded video sequence, and
2) Picture Parameter Sets (PPSs) that apply to the decoding of one or more individual pictures within a coded video sequence.

The sequence and picture parameter set mechanism decouples the transmission of infrequently changing information from the transmission of coded representations of the values of the samples in the video pictures. Each VCL NALU contains an identifier that refers to the content of the relevant PPS and each PPS contains an identifier that refers to the content of the relevant SPS. In this manner, a small amount of data (the identifier) can be used to refer to a larger amount of information (the parameter set) without repeating that information within each VCL NALU.

Sequence and picture parameter sets can be sent well ahead of the VCL NALUs that they apply to, and can be repeated to provide robustness against data loss. In some applications, parameter sets may be sent within the channel that carries the VCL NALUs (termed “in-band” transmission). In other applications, it can be advantageous to convey the parameter sets “out-of-band” using a more reliable transport mechanism than the video channel itself. A parameter set includes all picture, GOP, and sequence level data and includes a unique identifier. Each slice header includes a reference to the parameter set identifier, and the parameter values included as part of the referenced parameter set are used to decode the slice.

In session setup, the initial parameter sets can be sent to the client as a Multipurpose Internet Mail Extension (MIME) media type parameter included in the session description using SDP. During the session, if update of a particular parameter set is required, it can be transported using RTP in the same manner as VCL NALUs. i.e. using in-band transmission. Such a parameter set update is used to update one of the existing parameter sets after the session has begun.

Multiple SPSs and multiple PPSs may be contained in the initial parameter sets. There is a desire to enable multiple sequence or picture parameters in the initial parameter sets because some characteristics of the transmission or media may change during the session. In any particular VCL NALU, only a certain SPS and a certain PPS are used. Each VCL NALU contains an identifier that refers to the content of the relevant PPS and each PPS contains an identifier that refers to the content of the relevant SPS. This determines which SPS and PPS is used in decoding each VCL NALU.

According to the prior art, it is not possible to transmit new parameter sets or updates to existing parameter sets out-of-band during a PSS session. Such a new parameter set is a SPS whose SPS identifier is not equal to any present SPS identifier or a PPS whose PPS identifier is not equal to any present PPS identifer that is to be added after the session has begun. Because in-band transmission is unreliable even when repeated or using other enhanced transmission techniques such as Forward Error Correction (FEC), reliable out-of-band transmission of a new or updated parameter set is ideal. A quick and un-optimized solution could be to update the whole session using the RTSP ANNOUNCE method.

The ANNOUNCE method serves two purposes. First, when sent from a client to a server, the ANNOUNCE method posts the description of a presentation or media object identified by the request URL to a server. Second, when sent from the server to the client, the ANNOUNCE method updates the session description in real-time. If a new media stream is added to a presentation (e.g., during a live presentation), the entire presentation description should be sent again, instead of modifying just the subset of components that have changed. Thus, usage of the ANNOUNCE method to update video coding parameter sets involves significant delay because termination of the old session and initialization of a new session starting from the session setup phase is required.

Furthermore, due to the lack of synchronization information for each contained parameter in SDP, all of the parameters contained in an SDP description are applicable from the beginning of a session. This makes it impossible to transmit a parameter set update in PSS session setup phase. Synchronization information would be used to indicate at what point in the session the associated parameter set should be applied.

What is needed is a reliable, responsive system and method of transmitting new or updated existing parameter sets after session setup. What is further needed is a reliable, responsive system and method of transmitting parameter set updates during session setup.

### SUMMARY OF THE INVENTION

An exemplary embodiment of the invention relates to a device for updating a parameter set in streaming applications. The device includes a communication interface, a streaming media application, and a processor. The communication interface is configured to receive a first parameter set and to receive an updated parameter set having synchronization information using a Real Time Streaming Protocol (RTSP) method. The streaming media application is configured to process a received bitstream using the received first parameter set and to process the received bitstream using the updated parameter set when the synchronization information indicates that the updated parameter set should be used. The processor is coupled to the communication interface and executes the streaming media application.

The updated parameter set may be a partial update to the first parameter set, a complete update to the first parameter set, and/or a new parameter set. The synchronization information may include, but is not limited to, a real-time transport protocol timestamp, a normal play time timestamp, network abstraction layer unit time, and a decoding order number. The updated parameter set may be received during a setup phase and/or after the setup phase. The RTSP method may include, but is not limited to, a SET_PARAMETER method, a GET_PARAMETER method, a PAUSE method, a PLAY method, a OPTIONS method, a DESCRIBE method, and a PING method. Wherein the RTSP method is a DESCRIBE Response method, a presentation description is included, wherein the presentation description uses a session description protocol.

An exemplary embodiment of the invention relates to a device for updating a parameter set in streaming applications. The device includes a communication interface, a streaming media application, and a processor. The communication interface is configured to receive a first parameter set during a session setup phase, to receive synchronization information using the Session Description Protocol (SDP) during the session setup phase, and to receive an updated parameter set having synchronization information using the SDP during the session setup phase. The streaming media application is configured to process a received bitstream using the received first parameter set and to process the received bitstream using the updated parameter set when the synchronization information indicates that the updated parameter set should be used. The processor is coupled to the communication interface and executes the streaming media application. The synchronization information may include, but is not limited to, a real-time transport protocol timestamp, a normal play time timestamp, network abstraction layer unit time, and a decoding order number. The updated parameter set may be a partial update to the first parameter set, a complete update to the first parameter set, and/or a new parameter set. The SDP may be received using a hypertext transfer protocol GET method

Yet another exemplary embodiment of the invention relates to a server device for updating a parameter set in streaming applications. The server device includes a communication interface, a streaming media application, and a processor. The communication interface is configure to send a first parameter set and to send an updated parameter set having synchronization information using a RTSP method. The streaming media application is configured to define the first parameter set and the updated parameter set. The processor couples to the communication interface and executes the streaming media application.

The updated parameter set may be a partial update to the first parameter set, a complete update to the first parameter set, and/or a new parameter set. The synchronization information may include, but is not limited to, a real-time transport protocol timestamp, a normal play time timestamp, network abstraction layer unit time, and a decoding order number. The updated parameter set may be received during a setup phase and/or after the setup phase. The RTSP method may include, but is not limited to, a SET_PARAMETER method, a GET_PARAMETER method, a PAUSE method, a PLAY method, a OPTIONS method, a DESCRIBE method, and a PING method. Wherein the RTSP method is a DESCRIBE Response method, a presentation description is included, wherein the presentation description uses a session description protocol.

Still another exemplary embodiment of the invention relates to a system for updating a parameter set in streaming applications. The system includes a first device and a second device. The first device includes a first communication interface, a first streaming media application, and a first processor. The first communication interface is configured to receive a first parameter set and to receive an updated parameter set having synchronization information using a RTSP method. The first streaming media application is configured to process a received bitstream using the received first parameter set and to process the received bitstream using the updated parameter set when the synchronization information indicates that the updated parameter set should be used. The first processor is coupled to the first communication interface and executes the first streaming media application.

The second device includes a second communication interface, a second streaming media application, and a second processor. The second communication interface is configure to send the first parameter set and to send the updated parameter set having synchronization information using the RTSP method. The second streaming media application is configured to define the first parameter set and the updated parameter set. The second processor couples to the second communication interface and executes the second streaming media application.

The updated parameter set may be a partial update to the first parameter set, a complete update to the first parameter set, and/or a new parameter set. The synchronization information may include, but is not limited to, a real-time transport protocol timestamp, a normal play time timestamp, network abstraction layer unit time, and a decoding order number. The updated parameter set may be received during a setup phase and/or after the setup phase. The RTSP method may include, but is not limited to, a SET_PARAMETER method, a GET_PARAMETER method, a PAUSE method, a PLAY method, a OPTIONS method, a DESCRIBE method, and a PING method. Wherein the RTSP method is a DESCRIBE Response method, a presentation description is included, wherein the presentation description uses a session description protocol.

Still another exemplary embodiment of the invention relates to a method of updating a parameter set in streaming applications. The method includes receiving a first parameter set from a server device at a client device, receiving an updated parameter set having synchronization information at the client device, wherein the updated parameter set is sent from the server device using a RTSP method, processing a bitstream received from the server device at the client device using the first parameter set, and processing the bitstream at the client device using the updated parameter set when the synchronization information indicates that the updated parameter set should be used.

The updated parameter set may be a partial update to the first parameter set, a complete update to the first parameter set, and/or a new parameter set. The synchronization information may include, but is not limited to, a real-time transport protocol timestamp, a normal play time timestamp, network abstraction layer unit time, and a decoding order number. The updated parameter set may be received during a setup phase and/or after the setup phase. The RTSP method may include, but is not limited to, a SET_PARAMETER method, a GET_PARAMETER method, a PAUSE method, a PLAY method, a OPTIONS method, a DESCRIBE method, and a PING method. Wherein the RTSP method is a DESCRIBE Response method, a presentation description is included, wherein the presentation description uses a session description protocol.

Still another exemplary embodiment of the invention relates to a computer program product for updating a parameter set in streaming applications. The computer program product includes computer code configured to receive a first parameter set, to receive an updated parameter set having synchronization information from a server device using a RTSP method, to process a bitstream received from the server device using the first parameter set, and to process the bitstream using the updated parameter set when the synchronization information indicates that the updated parameter set should be used.

The updated parameter set may be a partial update to the first parameter set, a complete update to the first parameter set, and/or a new parameter set. The synchronization information may include, but is not limited to, a real-time transport protocol timestamp, a normal play time timestamp, network abstraction layer unit time, and a decoding order number. The updated parameter set may be received during a setup phase and/or after the setup phase. The RTSP method may include, but is not limited to, a SET_PARAMETER method, a GET_PARAMETER method, a PAUSE method, a PLAY method, a OPTIONS method, a DESCRIBE method, and a PING method. Wherein the RTSP method is a DESCRIBE Response method, a presentation description is included, wherein the presentation description uses a session description protocol.

Still another exemplary embodiment of the invention relates to a computer program product for updating a parameter set in streaming applications. The computer program product includes computer code configured to define a first parameter set, to send the first parameter set to a client device, to define an updated parameter set, and to send the updated parameter set having synchronization information using a RTSP method.

The updated parameter set may be a partial update to the first parameter set, a complete update to the first parameter set, and/or a new parameter set. The synchronization information may include, but is not limited to, a real-time transport protocol timestamp, a normal play time timestamp, network abstraction layer unit time, and a decoding order number. The updated parameter set may be received during a setup phase and/or after the setup phase. The RTSP method may include, but is not limited to, a SET_PARAMETER method, a GET_PARAMETER method, a PAUSE method, a PLAY method, a OPTIONS method, a DESCRIBE method, and a PING method. Wherein the RTSP method is a DESCRIBE Response method, a presentation description is included, wherein the presentation description uses a session description protocol.

Other principal features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals will denote like elements.

FIG. 1 is an overview diagram of an RTP header.

FIG. 2 is an overview diagram of a message sequence between a client device and a server device in accordance with an exemplary embodiment.

FIG. 3 is an overview diagram of another message sequence between the client device and the server device in accordance with an exemplary embodiment.

FIG. 4 is an overview diagram of yet another message sequence between the client device and the server device in accordance with an exemplary embodiment.

FIG. 5 is a block diagram of the device in accordance with an exemplary embodiment.

FIG. 6 is a block diagram of the server device in accordance with an exemplary embodiment.

FIG. 7 is a block diagram of a system employing the server device and the client device in accordance with an exemplary embodiment.

### DETAILED DESCRIPTION OF THE PREFERRED EMBODIMENTS

Processing a stream refers to the ability of an application to play media streams like audio and video streams or simulation data streams in a continuous way while those streams are being transmitted to a client over a data network. A fundamental design concept of H.264 is the generation of self-contained packets. This is achieved by decoupling information that is relevant to more than one slice from the media stream itself. This higher layer meta information should be sent reliably, asynchronously and before the RTP packet stream that contains the slice packets is received. The SPS and PPS structures contain information such as picture size, optional coding modes used, and a macroblock to slice group map. All NALUs consist of a single NAL unit type octet, which also serves as the header of the RTP payload format. The payload of a NALU follows immediately.

An access unit is a set of NALUs and always contains a primary coded picture. In addition to the primary coded picture, an access unit may also contain one or more redundant coded pictures or other NALUs not containing slices or slice data partitions of a coded picture.

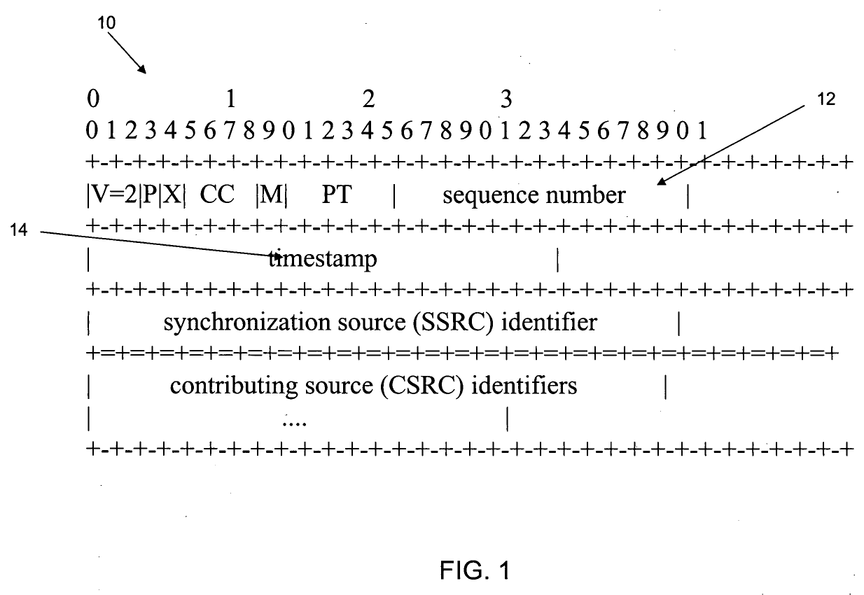

FIG. 1 shows the format of an RTP header 10. The RTP header 10 includes a sequence number 12 and a timestamp 14. The sequence number 10 is generally 16 bits and is defined and used in accordance with RFC 3550. For the single NALU and non-interleaved packetization mode, the sequence number is used to determine the decoding order for the NALU. The timestamp 12 is generally 32 bits and is set to the sampling timestamp of the content. The H.264/AVC RTP payload format specification defines rules for the utilization of and definition of the timestamp 12.

When multiple streams form a session, there is usually a need to synchronize the playing of these streams. Such synchronization requires correspondence of the Normal Play Time (NPT) clock to each media stream. NPT indicates the stream absolute position relative to the beginning of the presentation. The timestamp consists of a decimal fraction. The part left of the decimal point may be expressed in either hours, minutes, and seconds using a “:” between parameters or seconds. The part right of the decimal point measures fractions of a second. The beginning of a presentation corresponds to 0.0 seconds. Negative values are not defined. Typically, the RTSP PLAY Response method contains a Range header with NPT information and an RTP-Info header with a Universal Resource Locator (URL), sequence number, and timestamp of RTP packets that correspond to the NPT in the Range header. The Range header NPT information specifies a time interval to play.

For example, the RTSP PLAY Request method below, sent from the client to the server, requests play of seconds 10 through 15 of the media stream.
Client->Server: PLAY rtsp://audio.example.com/audio RTSP/1.0
   CSeq: 835
   Session: 12345678
   Range: npt=10-15

The RTSP PLAY Request method below, sent from the client to the server, requests play of seconds 30 through the end of the media stream.
Client->Server: PLAY rtsp://audio.example.com/audio RTSP/1.0
   CSeq: 837
   Session: 12345678
   Range: npt=30-

A Range of a-b starts exactly at time a, but stops just before b. The RTSP PAUSE Request method causes the stream delivery to be interrupted (halted) temporarily. A mapping from RTP timestamp value to NPT timestamp value (wall clock) is available using RTCP.

A parameter set update may be a complete parameter set update to an existing parameter set such that all of the parameters contained in the parameter set are included. Alternatively, a parameter set update may be a partial parameter set update to an existing parameter set such that only the parameters that change together with the parameter set identifier are included. When updating a parameter set, the updated parameters of a particular parameter set may be used directly to replace the corresponding parameters in the parameter set. If the original parameter set is still useful, however, a copy of the original parameter set may be created, and the updated parameters used to replace the corresponding parameters in the copy of the original parameter set. Additionally, a new parameter set may be included that is not associated with an existing parameter set. Thus, a new parameter set may be added to the existing parameter sets applied to the stream. The term “updated parameter set” comprises an existing parameter set that is partially updated, an existing parameter set that is completely updated, and a new parameter set that is added (i.e. is not associated with an existing parameter set).

In accordance with the prior art, the out-of-band transmission of one or more initial parameter sets may be accomplished using SDP contained in an RTSP Describe Response method. However, because each contained parameter in the SDP description lacks synchronization information, all of the parameters contained in the SDP description are applicable at the beginning of a session. This makes it impossible to transmit a parameter set update in PSS session setup phase.

According to an alternative embodiment, the out-of-band transmission of an updated parameter set during the session setup may be performed using SDP. SDP may be retrieved by a client through a number of means. The SDP file describing the live session may be published by the streaming server typically using one of the following mechanisms: manually transferring the SDP file using the File Transfer Protocol (FTP) from the live source host to the streaming server host, using a webserver, or using email, etc. Thus, for example, an HTTP GET method may be used to retrieve the SDP information. Synchronization information indicating when the transmitted parameter set update should be used must be provided because the SDP description is transmitted asynchronously with the in-band transmission of the VCL NALUs. In accordance with another alternative embodiment, out-of-band transmission of an updated parameter set during the session may be performed using an RTSP method. The synchronization information indicating when the transmitted updated parameter set should be used must be provided because the out-of-band transmission may be asynchronous with the in-band transmission of the VCL NALUs. The RTSP methods may be the SET_PARAMETER method, the PLAY Response method, or any other RTSP method that is used after session setup.

Synchronization of the updated parameter set with the VCL NALU stream is important because loss of synchronization will cause the decoding process to be incorrect or corrupted. To ensure that the VCL NALU stream is synchronized with the appropriate parameter set, the updated parameter set must take effect immediately before decoding of the first access unit where the updated parameter set is to be used, in decoding order. A preferred method of synchronization is to insert the updated parameter set NALU to the NALU stream at the beginning of any access unit from the first access unit (inclusive) after which the same value of seq_parameter_set_id or pic_parameter_set_id is not referenced and the first access unit (inclusive) where the updated parameter set is used, all in decoding order.

A decoding order number (DON) is a field in the payload structure or a derived variable indicating NALU decoding order. Values of DON are in the range of 0 to 65535, inclusive. After reaching the maximum value, the value of DON wraps around to 0. In the interleaved packetization mode, the transmission order of NALUs is allowed to differ from the decoding order of the NALUs. Thus, the DON indicates the NALU decoding order and allows a client receiving the NALUs to recover the decoding order. Thus, DON enables efficient multi-picture slice interleaving and robust packet scheduling because in both of these applications NALUs are transmitted out of decoding order.

Each access unit has an RTP timestamp or NALU time according to the specification of the RTP payload format for H.264 video. When transmitting the updated parameter set using an RTSP method, the timing information indicating the RTP timestamp or NALU time of the access unit should be provided such that the RTP timestamp of the updated parameter set can be derived. The derived RTP timestamp should then be equal to the RTP timestamp or NALU time of the access unit.

The time information may be provided by using a special RTSP header field, for example, the Range field defined in the RTSP specification (IETF RFC 2326). In streaming of pre-encoded media content, the Range field can be used with the normal NPT range format with only the starting time specified. For example, Range: npt=10- indicates that the updated parameter set should be inserted at the beginning of the first access unit whose RTP timestamp or NALU time is equal to or greater than (but also closest to) the RTP timestamp value that is derived from the NPT time value equal to 10. If needed, a new header may also be defined for the same purpose.

In the streaming of pre-encoded media content, the RTP timestamp can be one-to-one mapped to the NPT time, using the rtptime field as defined in the RTSP specification. On the server side, the NPT time should be set to the value equivalent to the RTP timestamp or NALU time of one instance of the access unit. In live streaming, a new header field can be defined similar to the Range field in the format of the RTP timestamp instead of the NPT time. For example, a new header field called ‘x-rtptimestamp’ can be defined with the syntax x-rtptimestamp: <RTP timestamp>. X-rtptimestamp indicates the RTP timestamp of the new or updated parameter set that is equal to the RTP timestamp or NALU time of one instance of the access unit. For example, x-rtptimestamp: 1032181. The x-rtptimestamp header field can also be used in the streaming of pre-encoded media content. Use of the x-rtptimestamp header field is preferably used for both the streaming of pre-encoded media content and live streaming.

A streaming session may be paused and resumed. After being paused and resumed, the pause period may be added to the original RTP timestamp of each access unit. In this case, the client should maintain a variable to count the total time amount of the pause periods and any other such periods. When mapping each updated parameter set to the access unit, the RTP timestamp value associated with the updated parameter set should be added by the total pause time in the same time unit as the RTP timestamp to correct for the pause time.

Any method of uniquely identifying an AVC access unit may be used to associate the updated parameter set with the corresponding access unit or NALU. The unique identification method provides the synchronization information. For example, preferably, the DON is used because it is not likely that the DON is changed due to a change in session control such as through a pause of the stream. Alternatively, the RTP timestamp may be used to map the times associated with the new or existing parameter set with the corresponding access unit or NALU.

Thus, the synchronization information may be DON, RTP timestamp, or any other information that can uniquely define an access unit or a NALU during the session. According to the synchronization information, during the session, each updated parameter set can be properly synchronized with the NALU stream, for example, by insertion of the updated parameter set into the NALU stream at the beginning of the first access unit where the updated parameter set should be used.

The RTSP header fields that may be used with the RTSP method to include the entire parameter set are x-avcparamset: <H.264/AVC parameter sets>; x-avcseqparamset: <H.264/AVC SPS>; and x-avcpicparamset: <H.264/AVC PPS>. The RTSP header field x-avcparamset may include one or more instances of new or updated existing parameter sets in the base64 representation of the parameter set NALUs as specified in sections 7.3.2.1 and 7.3.2.2 of the H.264/AVC specification. The parameter sets are conveyed in decoding order and no framing of the parameter set NALUs occurs. A comma is used to separate any pair of parameter sets in the list. The RTSP header field x-avcseqparamset provides one or more instances of new or updated existing SPSs in the base64 representation of the SPS NALU as specified in section 7.3.2.1 of the H.264/AVC specification. The RTSP header field x-avcpicparamset provides one or more instances of new or updated existing PPSs in the base64 representation of the PPS NALU as specified in section 7.3.2.2 of the H.264/AVC specification.

The SDP fields that may be used within the SDP description and correspond to the above described RTSP header fields are: a=x-avcparamset: <H.264/AVC parameter sets>; a=x-avcseqparamset: <H.264/AVC SPS>; and a=x-avcpicparamset: <H.264/AVC PPS>.

The RTSP header fields that may be used with the RTSP method to include a partial parameter set update include x-avcseqparamsetud: <parameter name>=<parameter value>, and a=x-avcpicparamsetud: <parameter name>=<parameter value>. The RTSP header field x-avcseqparamsetud: provides the updated parameter value of an SPS update. The parameter name is the same as any syntax element specified in section 7.3.2.1 of the H.264/AVC specification. The parameter value is represented in decimal format. The seq_parameter_set_id must be present, and preferably, is in the first line. For a syntax element that may appear more than once in an SPS, e.g. offset-for_ref_frame[ i ], the index, e.g. ‘i’, in the parameter name must be a valid value, e.g., 0, 1, 2 and so on. For example, the following SPS update parameters may be specified:
x-avcseqparamsetud: seq_parameter_set_id=2
x-avcseqparamsetud: redundant pictures_allowd_flag=1
x-avcseqparamsetud: num_ref_frames=3
x-avcseqparamsetud: offset_for_ref_frame[2]=0

Alternatively, all of the parameter names and values may be put in the same line separated by a comma. Thus, the above example becomes: x-avcseqparamsetud: seq_parameter_set_id=2, redundant_pictures_allowd_flag=1, num_ref_frames=3, offset_for_ref_frame[2]=0. It is also possible for each line to contain more than one SPS update.

The RTSP header field x-avcpicparamsetud: provides the updated parameter value of a PPS update. The parameter name is the same as for any syntax element specified in section 7.3.2.2 of the H.264/AVC specification. The parameter value is represented in decimal format. The pic_parameter_set_id must be present, and preferably, is in the first line. For the syntax element that may appear more than once in a PPS, e.g. top_left[iGroup], the index, e.g. ‘iGroup’, in the parameter name must be a valid value, e.g., 0, 1, 2 and so on. For example, the following PPS update parameters may be specified:
x-avcpicparamsetud: pic_parameter_set_id=2
x-avcpicparamsetud: pic_order_present_flag=0
x-avcpicparamsetud: num_ref_idx_{—}10_active_minus1=2
x-avcpicparamsetud: top_left[1]=9

Alternatively, all of the parameter names and values may be put in the same line separated by a comma. Thus, the above example becomes: x-avcpicparamsetud: pic_parameter_set_id=2, pic_order_present_flag=0, num_ref_idx_{—}10_active_minus1=2, top_left[1]=9. It is also possible for each line to contain more than one PPS update.

The syntax of the SDP fields that correspond to the RTSP fields for partial parameter set update are: a=x-avcseqparamsetud: <parameter name>=<parameter value>and a=x-avcpicparamsetud: <parameter name>=<parameter value>. Updated parameters for both SPS update and PPS update may also be included in the same line by using another newly defined field header. For example, a new RTSP header field could be designated x-avcparamsetud, and the corresponding new SDP field could be designated a=x-avcparamsetud. The parameter names and values may be placed on separate lines or, alternatively, may be placed in the same line separated by a comma.

The header field for timing information, e.g. the Range field or the x-rtptimestamp field, may also be used as a parameter associated with each updated parameter set, indicating the RTP timestamp, directly or indirectly, for the particular parameter set. In this way, one RTSP method can be used to send more than one updated parameter set that has different RTP timestamps, or in other words, the updated parameter sets take effect at different time instances.

The syntax of the SDP field that corresponds to the RTSP header field x-rtptimestamp can be a=x-rtptimestamp: <RTP timestamp>. When there is more than one instance of the parameter set update in an SDP description, each line of a=x-rtptimestamp: <RTP timestamp> can be followed with one or more lines of a=x-avcparamset, a=x-avcseqparamset, a=x-avcpicparamset, a=x-avcseqparamsetud, a=x-avcpicparamsetud, and/or a=avcseqpicparamsetud. The updated parameter sets following the a=x-rtptimestamp: <RTP timestamp> have the RTP timestamp equal to the RTP timestamp value signaled by the a=x-rtptimestamp parameter.

Alternatively, and preferably, the RTP timestamp can be included in the SDP fields, a=x-avcparamset, a=x-avcseqparamset, and/or a=x-avcpicparamset, that contain the parameter set to indicate the RTP timestamp of the contained parameter set. Each parameter set can be associated with one RTP timestamp field that is either before or after the parameter set itself in the SDP description, separated by a comma or a space. Alternatively, in the SDP field a=x-avcparamset, a single RTP timestamp field can be included either at the beginning or at the end of the parameter set separated by a comma. Using this mechanism, the RTP timestamp field can apply to all of the parameter sets contained in the a=x-avcparamset SDP field. In yet another alternative, each line of a=x-rtptimestamp can be applicable to all of the lines that follow until the next a=x-rtptimestamp field in the SDP description is encountered.

As noted in the RFC 2326 document, the RTSP DESCRIBE method, when sent from a client to a server, retrieves the description of a presentation or media object identified by the request URL from a server. The method may use the Accept header to specify the description formats that the client understands. The server responds with a description of the requested resource. The DESCRIBE reply-response pair constitutes the media initialization or setup phase of RTSP. A client device may obtain the presentation description from a source other than the DESCRIBE method. For example, an SDP file that is manually transferred may be used to define the presentation description. Additionally, SDP content may be included in the DESCRIBE Response method. An example DESCRIBE reply-response pair is shown below:
Client->Server: DESCRIBE rtsp://server.example.com/fizzle/foo RTSP/1.0
   CSeq: 312
   Accept: application/sdp, application/rtsl, application/mheg
Server->Client: RTSP/1.0 200 OK
   CSeq: 312
   Date: 23 Jan. 1997 15:35:06 GMT
   Content-Type: application/sdp
   Content-Length: 376
   v=0
   o=mhandley 2890844526 2890842807 IN IP4 126.16.64.4
   s=SDP Seminar
   i=A Seminar on the session description protocol
   u=http://www.cs.ucl.ac.uk/staff/M.Handley/sdp.03.ps
   e=mjh@isi.edu (Mark Handley)
   c=IN IP4 224.2.17.12/127
   t=2873397496 2873404696
   a=recvonly
   m=audio 3456 RTP/AVP 0
   m=video 2232 RTP/AVP 31
   m=whiteboard 32416 UDP WB
   a=orient:portrait

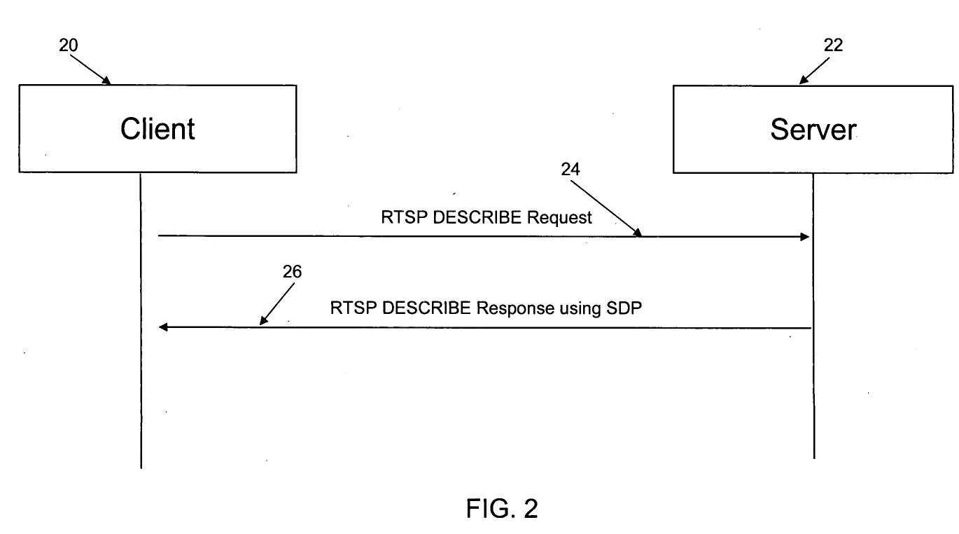

FIG. 2 illustrates the out-of-band transmission of one or more updated parameter sets using SDP. A client 20 initiates the setup process by sending an RTSP DESCRIBE Request method 24 to the media server 22. The media server 22 responds with an RTSP DESCRIBE Response method 26. The RTSP DESCRIBE Response method 26 includes SDP content that contains one or more initial parameter sets and/or updated parameter sets as discussed above using, for example, decoding order (e.g. DON) or RTP timestamp as the synchronization information for each parameter set update. As a result, the client 20 knows when each updated parameter set should be used during the session.

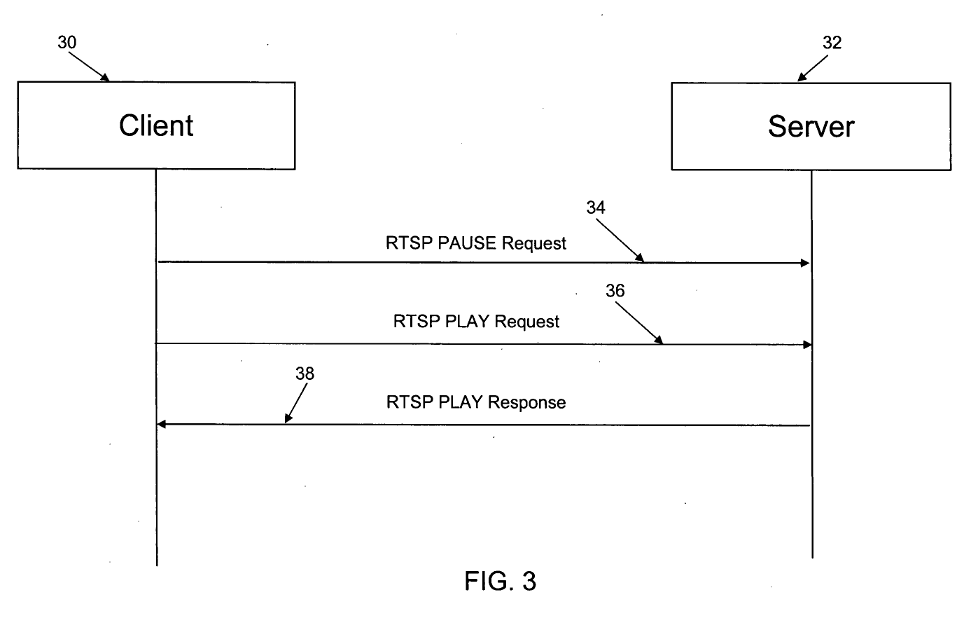

FIG. 3 illustrates a method of transmission of updated parameter sets using the RTSP PLAY Response method. The RTSP session has already started and the bitstream is being received from the server 32 at the client 30. The client 30 sends an RTSP PAUSE Request method 34 to the server 32 temporarily halting the bitstream transmission. The client 30 sends an RTSP PLAY Request method 36 with a certain playback range to the server 32 when it is prepared to begin receiving the bitstream again. In response, the server 32 sends an RTSP PLAY Response method 38 that contains updated parameter sets as discussed above using, for example, decoding order (e.g. DON) or RTP timestamp or NPT time as synchronization information for the new and/or updated parameter sets. As a result, the client 30 knows when each parameter set should be used during the new PLAY range.

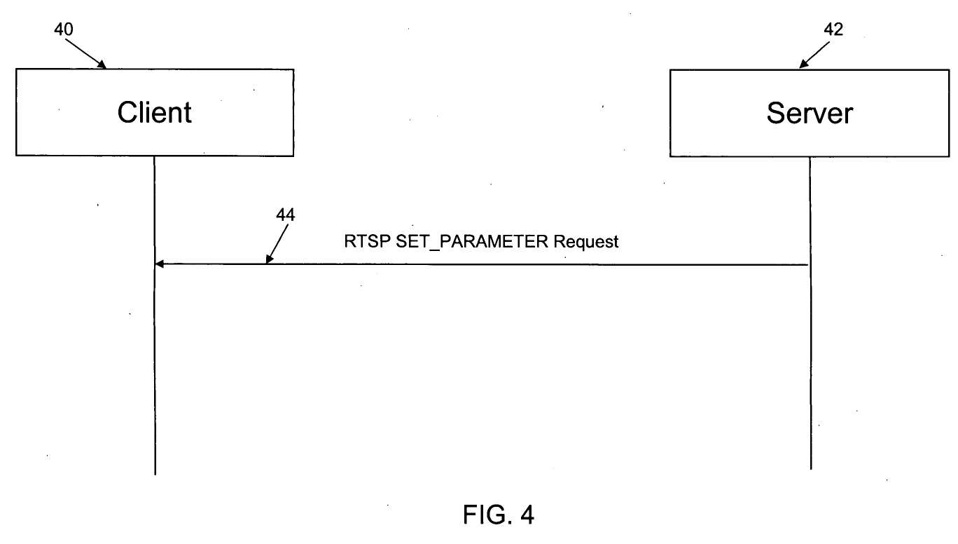

FIG. 4 illustrates an alternative and preferable method of transmitting updated parameter sets and of maintaining synchronization using the RTSP SET_PARAMETER method. The RTSP SET_PARAMETER method request is used to set the value of a parameter for a presentation or stream specified by the URI. The RTSP session has already started and the bitstream is being received from the server 42 at the client 40. The server 42 sends the RTSP SET_PARAMETER Request method 44 that contains updated parameter sets as discussed above using, for example, decoding order (e.g. DON) or RTP timestamp or NPT time as synchronization information for the new and/or updated parameter sets. As a result, the client 40 knows when each updated parameter set should be updated or used during the session.

The RTSP methods and SDP methods described above may be used independently or in combination. Additional, RTSP methods may be used to provide updated parameter sets. Additional RTSP methods include, but are not limited to, a GET_PARAMETER method, a PAUSE method, an OPTIONS method, a PING method, etc.

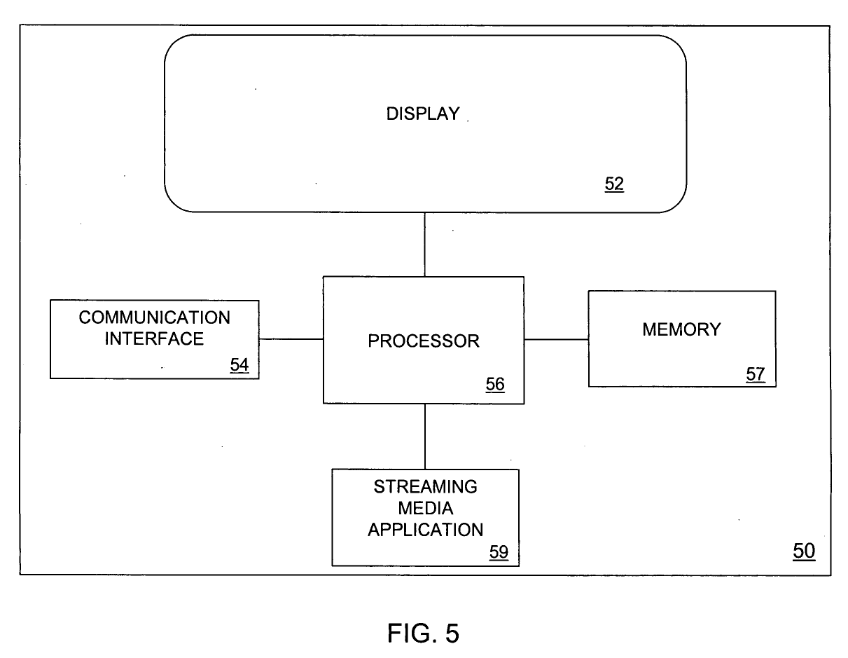

In a preferred embodiment, a client device 50, as shown in FIG. 5, comprises a display 52, a communication interface 54, a processor 56, a memory 57, and a streaming media application 59. The term “device” should be understood to include, without limitation, cellular telephones, Personal Data Assistants (PDAs), such as those manufactured by PALM, Inc., Instant Messaging Devices (IMD), such as those manufactured by Blackberry, Inc., and other hand-held devices; computers of all form factors; etc. A device may or may not be mobile. The exact architecture of the client device 50 is not important. Different and additional device compatible devices may be incorporated into the client device 50.

The display 52 presents information to a user. The display 52 may be a thin film transistor (TFT) display, a light emitting diode (LED) display, a Liquid Crystal Display (LCD), or any of a variety of different displays known to those skilled in the art.

The communication interface 54 provides an interface for receiving and transmitting calls, messages, and any other information communicated across a network including streaming media. Communications between the client device 50 and the network may be through one or more of the following connection methods, without limitation: an infrared communications link, a wireless communications link, a cellular network link, a physical serial connection, a physical parallel connection, a link established according to the Transmission Control. Protocol/Internet Protocol and Standards (TCP/IP), etc. Transferring content to and from the device may use one or more of these connection methods.

The processor 56 executes instructions that cause the client device 50 to behave in a predetermined manner. The instructions may be written using one or more programming languages, scripting languages, assembly languages, etc. Additionally, the instructions may be carried out by a special purpose computer, logic circuits, or hardware circuits. Thus, the processor 56 may be implemented in hardware, firmware, software, or any combination of these methods. The term “execution” is the process of running a program or the carrying out of the operation called for by an instruction. The processor 56 executes an instruction, meaning that it performs the operations called for by that instruction. The processor 56 executes the instructions embodied in the streaming media application 59.

Launching the streaming media application 59 generally requires retrieving the executable form of the application from a permanent memory device and copying the executable to a temporary memory device. The temporary memory device is generally some form of random access memory (RAM). The data in RAM is volatile meaning that it remains only as long as the computer is turned on. When the computer is turned off, RAM loses its data. Read only memory (ROM) refers to special memory used to store programs that boot the computer and perform diagnostics. The values stored in ROM are always there, whether the power is on or not. For this reason, it is called non-volatile memory. Flash memory is a type of constantly-powered nonvolatile memory that can be erased and reprogrammed in units of memory called blocks.

The memory 57 may hold an operating system of the client device 50, the streaming media application 59, other applications, and data so that the information can be reached quickly by the processor 56. The device may have a plurality of memories 57 using different memory technologies including, but not limited to, RAM, ROM, flash memory, and the like.

The streaming media application 59 is built on top of streaming services that may include on-demand and live information delivery. The streaming media application 59 may display or otherwise process media or data streams. The streams may be for on-demand use or for live information delivery. The streaming media application 59 implements one or more of the updated parameter set synchronization methods discussed previously.

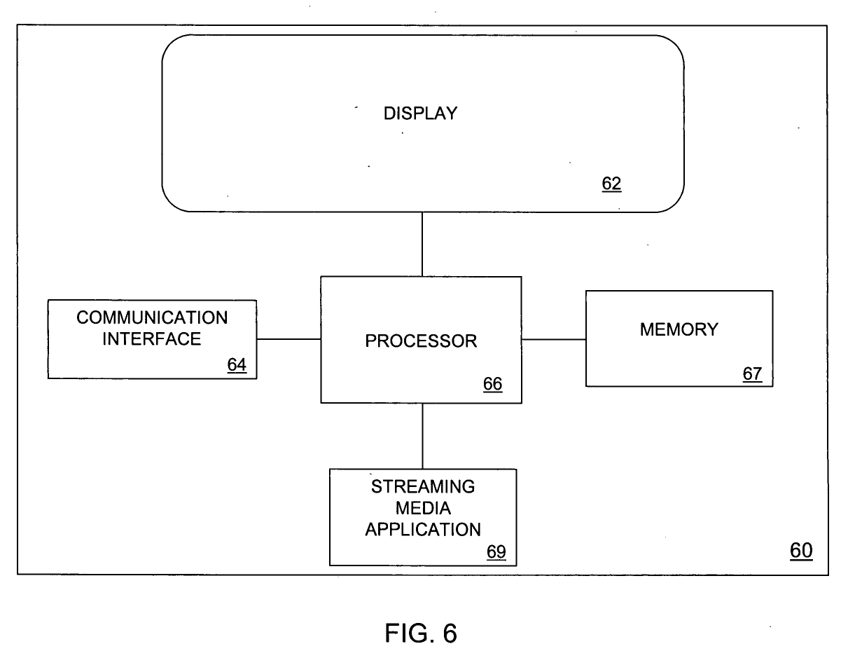

In a preferred embodiment, a server device 60, as shown in FIG. 6, comprises a display 62, a communication interface 64, a processor 66, a memory 67, and a streaming media application 69. The exact architecture of the server device 60 is not important. Different and additional device compatible devices may be incorporated into the server device 60. The display 62 presents information to a user. The display 62 may be a thin film transistor (TFT) display, a light emitting diode (LED) display, a Liquid Crystal Display (LCD), or any of a variety of different displays known to those skilled in the art.

The communication interface 64 provides an interface for receiving and transmitting calls, messages, and any other information communicated across a network including streaming media. Communications between the server device 60 and the network may be through one or more of the following connection methods, without limitation: an infrared communications link, a wireless communications link, a cellular network link, a physical serial connection, a physical parallel connection, a link established according to the Transmission Control Protocol/Internet Protocol and Standards (TCP/IP), etc. Transferring content to and from the server device 60 may use one or more of these connection methods.

The processor 66 executes instructions that cause the server device 60 to behave in a predetermined manner. The instructions may be written using one or more programming languages, scripting languages, assembly languages, etc. Additionally, the instructions may be carried out by a special purpose computer, logic circuits, or hardware circuits. Thus, the processor 66 may be implemented in hardware, firmware, software, or any combination of these methods. The processor 66 executes an instruction, meaning that it performs the operations called for by that instruction. The processor 66 executes the instructions embodied in the streaming media application 69.

Launching the streaming media application 69 generally requires retrieving the executable form of the application from a permanent memory device and copying the executable to a temporary memory device. The temporary memory device is generally some form of random access memory (RAM). The data in RAM is volatile meaning that it remains only as long as the computer is turned on. When the computer is turned off, RAM loses its data. Read only memory (ROM) refers to special memory used to store programs that boot the computer and perform diagnostics. The values stored in ROM are always there, whether the power is on or not. For this reason, it is called non-volatile memory. Flash memory is a type of constantly-powered nonvolatile memory that can be erased and reprogrammed in units of memory called blocks.

The memory 67 may hold an operating system of the device 60, the streaming media application 69, other applications, and data-so that the information can be reached quickly by the processor 66. The device may have a plurality of memories 67 using different memory technologies including, but not limited to, RAM, ROM, flash memory, and the like.

The streaming media application 69 is built on top of streaming services that may include on-demand and live information delivery. The streaming media application 69 may transmit or otherwise process media or data streams. The streams may be for on-demand use or for live information delivery. The streaming media application 69 implements one or more of the updated parameter set synchronization methods discussed previously.

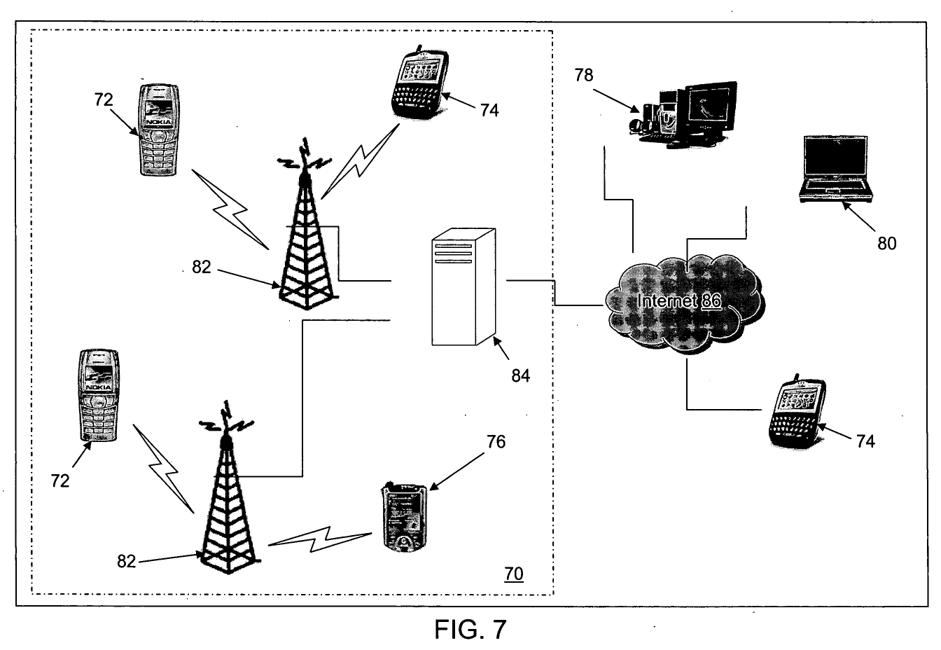

With reference to FIG. 7, the system 70 comprises devices, a base station 82, and a network server 84. The devices may include a cellular telephone 72, an IMD 74, a PDA 76, and the like. In the system 70, the devices may send and receive signals through the base station 82. The network server 84 allows communication between the devices and a broader network. For example, the network server 84 may connect the devices with other devices through the Internet 86.

It is understood that the invention is not confined to the particular embodiments set forth herein as illustrative, but embraces all such modifications, combinations, and permutations as come within the scope of the following claims. Thus, the description of the exemplary embodiments is for purposes of illustration and not limitation.

1. A device for updating a parameter set in streaming applications, the device comprising:
a communication interface, wherein the communication interface is configured to:
receive a first parameter set; and
receive an updated parameter set having synchronization information using a Real Time Streaming Protocol (RTSP) method;
a streaming media application, wherein the streaming media application is configured to:
process a received bitstream using the received first parameter set; and
process the received bitstream using the updated parameter set when the synchronization information indicates that the updated parameter set should be used; and
a processor coupled to the communication interface that executes the streaming media application.

2. The device of claim 1, wherein the updated parameter set is a partial update to the first parameter set.

3. The device of claim 1, wherein the updated parameter set is a complete update to the first parameter set.

4. The device of claim 1, wherein the updated parameter set is a new parameter set.

5. The device of claim 1, wherein the updated parameter set is received during a setup phase.

6. The device of claim 5, wherein the RTSP method is a DESCRIBE Response method that includes a presentation description, wherein the presentation description uses a session description protocol.

7. The device of claim 1, wherein the updated parameter set is received after a setup phase.

8. The device of claim 7, wherein the RTSP method is a SET_PARAMETER method.

9. The device of claim 7, wherein the RTSP method is a GET_PARAMETER method.

10. The device of claim 7, wherein the RTSP method is a PAUSE method.

11. The device of claim 7, wherein the RTSP method is a PLAY method.

12. The device of claim 7, wherein the RTSP method is a OPTIONS method.

13. The device of claim 7, wherein the RTSP method is a PING method.

14. The device of claim 1, wherein the synchronization information is a real-time transport protocol timestamp.

15. The device of claim 1, wherein the synchronization information is a normal play time timestamp.

16. The device of claim 1, wherein the synchronization information is a network abstraction layer unit time.

17. The device of claim 1, wherein the synchronization information is a decoding order number.

18. A device for updating a parameter set in streaming applications, the device comprising:
a communication interface, wherein the communication interface is configured to:
receive a first parameter set during a session setup phase;
receive synchronization information using a Session Description Protocol (SDP) during the session setup phase; and
receive an updated parameter set using the SDP during the session setup phase;
a streaming media application, wherein the streaming media application is configured to:
process a received bitstream using the received first parameter set; and
process the received bitstream using the updated parameter set when the synchronization information indicates that the updated parameter set should be used; and
a processor coupled to the communication interface that executes the streaming media application.

19. The device of claim 18, wherein the SDP is received using a hypertext transfer protocol GET method.

20. A server device for updating a parameter set in streaming applications, the server device comprising:
a communication interface, wherein the communication interface is configured to:
send a first parameter set; and
send an updated parameter set having synchronization information using a Real Time Streaming Protocol (RTSP) method;
a streaming media application, wherein the streaming media application is configured to define the first parameter set and the updated parameter set; and
a processor coupled to the communication interface that executes the streaming media application.

21. A system for updating a parameter set in streaming applications, the system comprising:
a first device, the first device comprising:
a first communication interface, wherein the first communication interface is configured to:
receive a first parameter set; and
receive an updated parameter set having synchronization information using a Real Time Streaming Protocol (RTSP) method;
a first streaming media application, wherein the first streaming media application is configured to:
process a received bitstream using the received first parameter set; and
process the received bitstream using the updated parameter set when the synchronization information indicates that the updated parameter set should be used; and
a first processor coupled to the first communication interface that executes the first streaming media application; and
the second device comprising:
a second communication interface, wherein the second communication interface is configured to:
send the first parameter set; and
send the updated parameter set having synchronization information using the RTSP method;
a second streaming media application, wherein the second streaming media application is configured to define the first parameter set and the updated parameter set; and
a second processor coupled to the second communication interface that executes the second streaming media application.

22. A method of updating a parameter set in streaming applications, the method comprising:
receiving a first parameter set from a server device at a client device;
receiving an updated parameter set having synchronization information at the client device, wherein the updated parameter set is sent from the server device using a Real Time Streaming Protocol (RTSP) method;
processing a bitstream received from the server device at the client device using the first parameter set; and
processing the bitstream at the client device using the updated parameter set when the synchronization information indicates that the updated parameter set should be used.

23. A computer program product for updating a parameter set in streaming applications, the computer program product comprising:
computer code configured to:
receive a first parameter set;
receive an updated parameter set having synchronization information from a server device using a Real Time Streaming Protocol (RTSP) method;
process a bitstream received from the server device using the first parameter set; and
process the bitstream using the updated parameter set when the synchronization information indicates that the updated parameter set should be used.

24. A computer program product for updating a parameter set in streaming applications, the computer program product comprising:
computer code configured to:
define a first parameter set;
send the first parameter set to a client device;
define an updated parameter set; and
send the updated parameter set having synchronization information using a Real Time Streaming Protocol (RTSP) method.
